(19) United States
(12) Patent Application Publication
(10) Pub. No.: US 2014/0303804 A1
(43) Pub. Date: Oct. 9, 2014

(54) METHOD OF CONTROLLING A THERMAL BUDGET OF AN INTEGRATED CIRCUIT DEVICE, AN INTEGRATED CIRCUIT, A THERMAL CONTROL MODULE AND AN ELECTRONIC DEVICE THEREFOR

(71) Applicants: Michael Priel, Netanya (IL); Roy Drucker, Rishon Le Zion (IL); Dan Kuzmin, Givat Shmuel (IL)

(72) Inventors: Michael Priel, Netanya (IL); Roy Drucker, Rishon Le Zion (IL); Dan Kuzmin, Givat Shmuel (IL)

(73) Assignee: FREESCALE SEMICONDUCTOR, INC., Austin, TX (US)

(21) Appl. No.: 14/354,286

(22) PCT Filed: Nov. 4, 2011
(86) PCT No.: PCT/IB2011/054917

§ 371 Date: Apr. 25, 2014

(51) Int. Cl. G05D 23/19

(52) U.S. Cl. CPC G05D 23/19
USPC 700/299

(57) ABSTRACT

A method of controlling a thermal budget of an integrated circuit device is described. The method comprises obtaining a first junction temperature measurement value for the integrated circuit device at a first time instant, and a further junction temperature measurement value for the integrated circuit device at a further time instant. The method further comprises calculating a prospective junction temperature value for the integrated circuit device at a future time instant based at least partly on the first and further junction temperature measurement values; and configuring an operating condition of the integrated circuit device based at least partly on the calculated prospective junction temperature value.

### FIELD OF THE INVENTION

The field of this invention relates to a method of controlling a thermal budget for an integrated circuit device, an integrated circuit device, a thermal control module and an electronic device therefor.

### BACKGROUND OF THE INVENTION

Integrated circuit devices, and in particular integrated circuit devices (IC's) intended for use within mobile products, such as mobile communication devices and the like, are typically designed for high performance and functionality. However, such integrated circuit devices are often limited by a thermal budget with strong dependence on the actual product within which they are used and on ambient temperature. This makes thermal budget control of ICs of critical importance in order to achieve maximum effective performance of the integrated circuit device. For clarity, the term ‘thermal budget’ used herein refers to an amount of thermal energy transferred to the die of the integrated circuit device.

Conventional thermal budget control systems comprise temperature sensors in conjunction with hardware and/or software algorithms for changing device operation in reaction to measured temperatures. Typically, such control systems utilise frequency scaling and/or power gating to control the device operation, and thus to control the thermal budget for the device.

However, there are several problems with such a reactive technique for controlling the thermal budget of an integrated circuit device. Firstly, such reactive techniques do not take into account specific temperatures, but typically involve a general reaction to a measured temperature exceeding a predefined threshold value. However, often under such circumstances the thermal budget is only exceeded by a relatively small amount, and the excessive response typically employed by conventional reactive systems is often unnecessarily aggressive. Secondly, the frequency scaling and/or power gating that is implemented within such conventional reactive systems typically comprises a coarse granularity between configurations. Accordingly, such conventional reactive systems have a significant impact on performance, due to the large ‘step-size’ between frequency scaling and/or power gating configurations. Thirdly, non-stable oscillations between frequency scaling and/or power gating configurations can occur around a desired or threshold temperature.

### SUMMARY OF THE INVENTION

The present invention provides a method of controlling a thermal budget for an integrated circuit device, an integrated circuit device, a thermal control module, an electronic device and a non-transitory computer program product therefor as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of a part of a wireless communication unit.

FIG. 2 illustrates a simplified block diagram of an example of part of an integrated circuit device.

FIG. 3 illustrates a graph of junction temperature over time for an integrated circuit device.

FIG. 4 illustrates a simplified flowchart of an example of a method of controlling a thermal budget of an integrated circuit device.

### DETAILED DESCRIPTION

The present invention will now be described with reference to an integrated circuit device for use in a wireless communication unit, and a method of controlling a thermal budget therefor. However, it will be appreciated that the present invention is not limited solely to wireless communication applications, but may be equally applied to any integrated circuit device application for which thermal budget control is required, or at least desired.

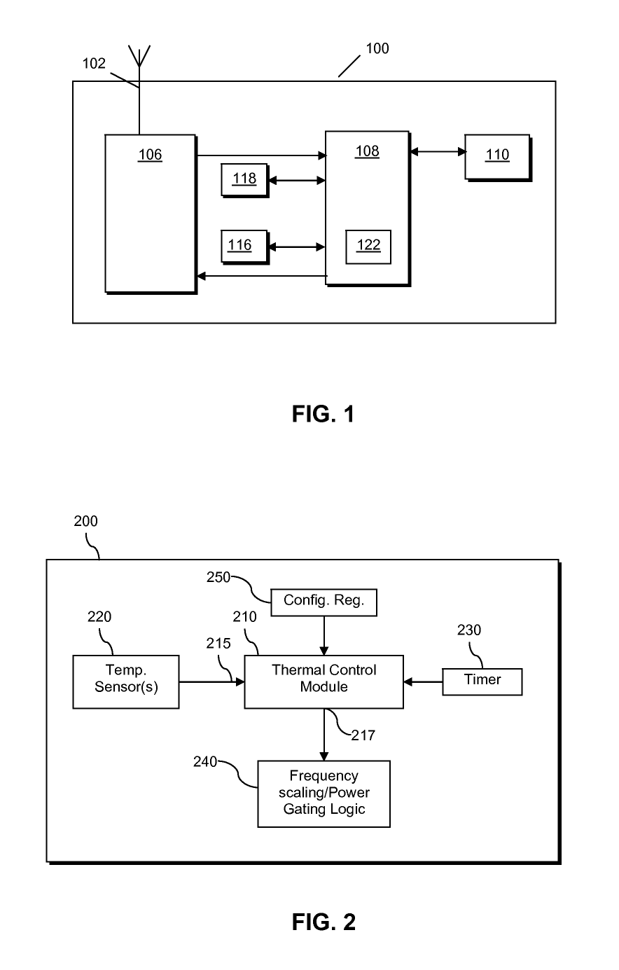

Referring first to FIG. 1, there is illustrated a simplified block diagram of an example of a part of a wireless communication unit 100. The wireless communication unit 100 is a mobile telephone handset comprising an antenna 102. As such, the wireless communication unit 100 contains a variety of well known radio frequency components or circuits 106, operably coupled to the antenna 102 that will not be described further herein. The wireless communication unit 100 further comprises signal processing logic 108. An output from the signal processing logic 108 is provided to a suitable user interface (UI) 110 comprising, for example, a display, keypad, microphone, speaker, etc.

For completeness, the signal processing logic 108 is coupled to a memory element 116 that stores operating regimes, such as decoding/encoding functions and the like and may be realised in a variety of technologies such as random access memory (RAM) (volatile), (non-volatile) read only memory (ROM), Flash memory or any combination of these or other memory technologies. A timer 118 is typically coupled to the signal processing logic 108 to control the timing of operations within the wireless communication unit 100.

Electronic devices such as the wireless communication unit 100 of FIG. 1 typically comprise a number of integrated circuit devices. For example, the wireless communication unit 100 of FIG. 1 may comprise one or more integrated circuit devices for implementing the radio frequency components or circuits 106; and one or more integrated circuit devices for implementing the signal processing logic 108; etc. Integrated circuit devices, and in particular integrated circuit devices intended for use within mobile products, such as mobile communication units and the like, are typically designed for high performance and functionality. In order to achieve increased, or indeed, maximum effective performance of the integrated circuit device, good thermal budget control is required for each integrated circuit device.

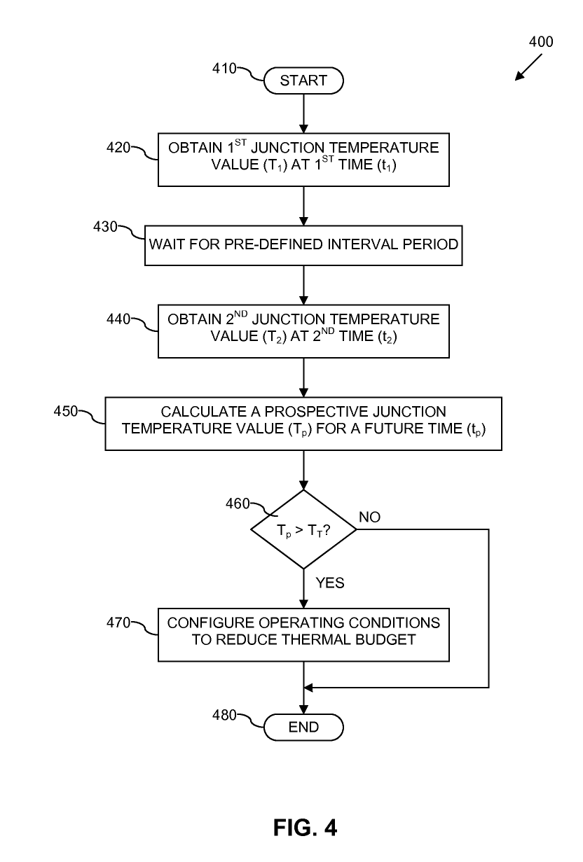

Referring now to FIG. 2, there is illustrated a simplified block diagram of an example of part of an integrated circuit device 200, such as may be implemented within the wireless communication unit 100 of FIG. 1. The integrated circuit device comprises a thermal control module 210 arranged to control a thermal budget of the integrated circuit device. In particular, and in accordance with some example embodiments of the present invention, the thermal control module 210 may be adapted to perform a method of controlling a thermal budget of the integrated circuit device 200 (as illustrated with the flowchart of FIG. 4). The method comprises: obtaining a first junction temperature measurement value for the integrated circuit device 200 at a first time instant; obtaining at least one further junction temperature measurement value for the integrated circuit device 200 at an at least one further time instant, calculating a prospective junction temperature value for the integrated circuit device 200 at a future time instant based at least partly on the first and at least one further junction temperature measurement values; and configuring at least one operating condition of the integrated circuit device 200 based at least partly on the calculated prospective junction temperature value.

In this manner, the thermal control module 210 is able to proactively configure the at least one operating condition of the integrated circuit device 200 in order to control the thermal budget therefor, based on the calculated junction temperature Tₚ. As such, improved control of the thermal budget of the integrated circuit device 200 may be achieved as compared with, say, conventional reactive techniques that are only arranged to configure operating conditions of an integrated circuit device once a measured junction temperature has already exceeded a threshold value.

For example, the inventors have recognised that the temperature of integrated circuit device components is predictable within a stable state system having a relatively constant power consumption. For example, the junction temperature of an integrated circuit device component may be approximately defined using the equation:

T=A*Ln(t)+B [Equation 1]

where T is the junction temperature for the integrated circuit device component, t=time, and A and B are constants that depend on system type and operating conditions.

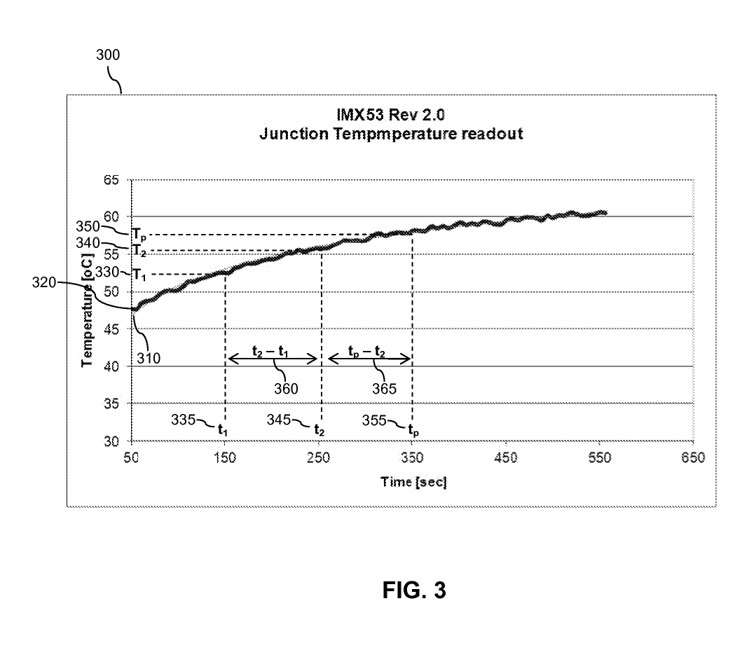

FIG. 3 illustrates a graph 300 of junction temperature over time comprising a first plot 310 representing Equation 1 above where:

y=5.7947 ln(x)+24.016 [Equation 2]

The graph 300 further comprises a second plot 320 of a measured junction temperature profile within an integrated circuit device over time. As illustrated by the two plots 310, 320, Equation 1 above provides an accurate definition of the junction temperature of an integrated circuit device, and for the case illustrated in FIG. 3, the correlation between the logarithmic equation (Equation 2) and the temperature profile is better than 99% aligned.

Thus, and as illustrated in FIG. 3, by taking a first junction temperature measurement T₁ 330 for the integrated circuit device 200 at a first time instant t₁ 335, and at least one further junction temperature measurement, such as the second junction temperature measurement T₂ 340 for the integrated circuit device 200 at a further time instant t₂ 345, it is possible to determine the values of the constants A and B in Equation 1 for a current (stable) operating state of the integrated circuit device 200, and thereby to calculate a junction temperature Tₚ 350 of a future time instant tₚ 255, under the current operating state of the integrated circuit device 200.

Accordingly, the thermal control module 210 of FIG. 2 may be arranged to obtain a first junction temperature measurement value T₁ 330 for the integrated circuit device 200 at a first time instant t₁ 335, obtain at least one further junction temperature measurement value T₂ 340 for the integrated circuit device 200 at an at least one further time instant t₂ 345, calculate a prospective junction temperature value T_{P} 350 for the integrated circuit device 200 at a future time instant tₚ 355 based at least partly on the first and at least one further junction temperature measurement values T₁ 330 and T₂ 340, and configure at least one operating condition of the integrated circuit device 200 based at least partly on the calculated prospective junction temperature value T_{P} 350. In the illustrated example, the thermal control module 210 comprising an input 215 connectable to one or more temperature sensors 220 from which the thermal control module 210 is arranged to receive junction temperature measurement values. The thermal control module 210 is further operably coupled to a timer 230 from which the thermal control module 210 is arranged to receive timing information in order to determine the various time instants t₁ 335, t₂ 345 and tₚ 355.

For some examples, the thermal control module 210 may be arranged to perform a steady state calculation (e.g. within a stable state system having constant power consumption) for the prospective junction temperature value T_{P} 350, for example based on Equation 1 above. Furthermore, the first time instant t₁ 335 and the at least one further time instant t₂ 345 may be spaced a constant, pre-defined interval (t₂−t₁) 360 apart, and the thermal control module 210 may be further arranged to calculate the prospective junction temperature value T_{P} 350 for the integrated circuit device 200 at a future time instant tₚ 355 where an interval between the at least one further time instant t₂ 345 and the future time instant tₚ 355 (tₚ−t₂) 365 is substantially equal to the (pre-defined) interval (t₂−t₁) 360.

Having calculated the prospective junction temperature value T_{P} 350, the thermal control module 210 may be arranged to compare the prospective junction temperature value T_{P} 355 with one or more threshold temperature values T_{T}, and if the prospective junction temperature value T_{P} 355 exceeds one or more of the threshold temperature values T_{T}, the thermal control module 210 may be arranged to configure at least one operating condition for the integrated circuit device 200 to reduce the thermal budget therefor. For example, a maximum operating temperature value for the integrated circuit device 200 may be set as the threshold temperature value T_{T}. In this manner, if the prospective junction temperature value T_{P} 350 exceeds this threshold temperature value T_{T}, the thermal control module 210 may proactively configure one or more operating conditions for the integrated circuit device 200 to reduce the thermal budget for the integrated circuit device 200, in order to avoid the junction temperature therefor exceeding the maximum operating temperature.

In the illustrated example the thermal control module 210 comprises a control output 217 operably coupled to a frequency scaling and power gating module 240. In this manner, the thermal control module 210 may be arranged to configure the frequency scaling and/or power gating module 240 to modify an operating frequency and/or power gating configuration of at least a part of the integrated circuit device 200 in order to reduce the thermal budget therefor. Additionally and/or alternatively the thermal control module 210 may be arranged to configure other operating conditions, such as by way of example only, a clock gating configuration and/or a power supply voltage level for at least a part of the integrated circuit device 200.

The thermal control module 210 may be further arranged to determine a configuration for one or more operating conditions of the integrated circuit device 200 required for a junction temperature of the integrated circuit device 200 to be below the threshold temperature T_{T} at the future time instant tₚ, and to configure the one or more operating conditions accordingly, if the prospective junction temperature value T_{P} 355 exceeds the threshold temperature value T_{T}. In some examples, the thermal control module 210 may be arranged to optimally configure one or more operating conditions of the integrated circuit device 200 in order to substantially increase, or indeed maximise, performance of the integrated circuit device 200 whilst remaining within a maximum thermal budget. In this manner, not only may the thermal control module 210 be arranged to proactively prevent a thermal budget for the integrated circuit device 200 exceeding, say, a maximum operating thermal budget, but also the thermal control module 210 may be arranged to optimally configure one or more operating conditions of the integrated circuit device 200 to enable substantially maximum performance of the integrated circuit device to be achieved without exceeding the maximum thermal budget. In this way, the thermal control module 210 is able to predict a stable temperature for a current power consumption of the integrated circuit device 200, and to change power consumption through changing operating conditions to target a desired temperature value.

In the illustrated example, the thermal control module 210 is further operably coupled to a configurable register 250 within which parameters such as, say, constants A and B of Equation 1, intervals (t₂−t₁) 360 and (tₚ−t₂) 365, and one or more threshold temperatures T_{T} may be programmable or configured and accessed by the thermal control module 210. In this manner, such parameters may be programmed and updated as required for individual applications and systems.

Referring now to FIG. 4 there is illustrated a simplified flowchart 400 of an example of a method of controlling a thermal budget of an integrated circuit device; for example as may be implemented by the thermal control module of FIG. 2. The method starts at 410, and moves on to 420 where a first junction temperature measurement value (T₁) is obtained at a first time instant (t₁). Next, at 430, the method waits for a pre-defined interval (t₂−t₁) before a second junction temperature measurement value (T₂) is obtained at a second time instant (t₂) at 440. Next, at 450, a prospective junction temperature value (Tₚ) is calculated for a future time instant (tₚ). The prospective junction temperature value (Tₚ) is then compared with a threshold temperature value (T_{T}) at 460, and if the prospective junction temperature value (Tₚ) is greater than the threshold temperature value (T_{T}), the method moves on to 470 where one or more operating conditions are configured to reduce a thermal budget for the integrated circuit device. The method then ends at 480. Referring back to 460, if the prospective junction temperature value (Tₚ) is not greater than the threshold temperature value (T_{T}), the method ends at 480.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Aspects of the invention may be implemented, at least in part, in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any type of non-transitory media such as: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc. The media may also be transitory, such as carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals. Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, for clarity, the temperature sensor(s) 220, timer 230, frequency scaling/power gating module 240 and configurable register 250 have been illustrated as comprising functional blocks distinct from the thermal control module 210. However, it will be appreciated that one or more of these functional elements may be implemented as an integral part of the thermal control module 210.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected’, or ‘operably coupled’, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an’, as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an’. The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of controlling a thermal budget of an integrated circuit device; the method comprising:
obtaining a first junction temperature measurement value for the integrated circuit device at a first time instant;
obtaining at least one further junction temperature measurement value for the integrated circuit device at an at least one further time instant;
calculating a prospective junction temperature value for the integrated circuit device at a future time instant based at least partly on the first junction temperature measurement value and the at least one further junction temperature measurement value; and
configuring at least one operating condition of the integrated circuit device based at least partly on the calculated prospective junction temperature value.

2. The method of claim 1, wherein the first time instant and the at least one further time instant are spaced a constant, pre-defined interval apart.

3. The method of claim 2, wherein an interval between the at least one further time instant and the future time instant is substantially equal to the constant pre-defined interval that the first time instant and the at least one further time instant are apart.

4. The method of claim 1, wherein the method comprises performing a steady state calculation for the calculated prospective junction temperature value.

5. The method of claim 1, wherein the method further comprises:
comparing the calculated prospective junction temperature value with a threshold temperature value; and
if the prospective junction temperature value exceeds the threshold temperature value, configuring the at least one operating condition for the integrated circuit device to reduce a thermal budget therefor.

6. The method of claim 5, wherein the method further comprises:
determining a configuration for the at least one operating condition of the integrated circuit device required for a junction temperature of the integrated circuit device to be below the threshold temperature at the future time instant; and
configuring the at least one operating condition accordingly, if the prospective junction temperature value exceeds the threshold temperature value.

7. The method of claim 6, wherein the method further comprises determining an optimal configuration for the at least one operating condition of the integrated circuit device required to increase performance of the integrated circuit device while remaining within a maximum thermal budget.

8. The method of claim 1, wherein the at least one operating condition comprises at least one from a group of:
an operating frequency of the integrated circuit device;
power gating configuration;
clock gating configuration; and
a power supply voltage level of the integrated circuit device.

9. An integrated circuit device comprising:
a temperature sensor;
at least one thermal control module comprising
an input, coupled to the temperature sensor, and configured to receive:
a first junction temperature measurement value for the integrated circuit device at a first time instant and
at least one further junction temperature measurement value for the integrated circuit device at at least one further time instant, wherein the at least one thermal control module is configured to
calculate a prospective junction temperature value for the integrated circuit device at a future time instant based at least partly on the first and at least one further junction temperature measurement values, and
a control output for configuring at least one operating condition of the integrated circuit device based at least partly on the calculated prospective junction temperature value.

10. A thermal control module comprising an input connectable to a temperature sensor for receiving:
a first junction temperature measurement value for the integrated circuit device at a first time instant; and
at least one further junction temperature measurement value for the integrated circuit device at at least one further time instant;
the at least one thermal control module being arranged to calculate a prospective junction temperature value for the integrated circuit device at a future time instant based at least partly on the first and at least one further junction temperature measurement values; and further comprising a control output for configuring at least one operating condition of the integrated circuit device based at least partly on the calculated prospective junction temperature value.

11. An electronic device comprising an integrated circuit device according to claim 9.

12-13. (canceled)
